(19) United States
(12) Patent Application Publication
(10) Pub. No.: US 2025/0031022 A1
(43) Pub. Date: Jan. 23, 2025

(54) Multiple Audio Stream Handling with Multi-Radio Bluetooth System

(71) Applicant: Google LLC, Mountain View, CA (US)

(72) Inventors: Xuemei Ouyang, Redwood City, CA (US); Dennis Yee, San Francisco, CA (US); Michael Scot Pate, Pleasanton, CA (US); Ethan Aren Grabau, London (GB); Chi Kin Benjamin Leung, Sunnyvale, CA (US)

(73) Assignee: Google LLC, Mountain View, CA (US)

(21) Appl. No.: 18/711,514

(22) PCT Filed: Nov. 30, 2022
(86) PCT No.: PCT/US2022/080644

§ 371 Date: May 17, 2024

Related U.S. Application Data
(60) Provisional application No. 63/284,165, filed on Nov. 30, 2021.

(51) Int. Cl. H04W 4/80; H04W 56/00; H04W 76/15

(52) U.S. Cl. CPC H04W 4/80; H04W 56/002; H04W 76/15

(57) ABSTRACT

This document discloses technology generally related to an accessory that may wirelessly connect to one or more host devices such that the accessory is able to receive content from two or more of the host devices simultaneously. The accessory may have two or more wireless communication interfaces connected to two or more respective host devices via a type of wireless connection. The accessory may determine a time to simultaneously receive content from and/or transmit content to each of the host devices. The time may be determined by adjusting the start times for reception and/or transmission of content from the two or more host devices, and/or it may be determined based on the type of wireless connection. According to some examples, the accessory may determine a priority for each of the wireless connections using arbitration rules. The accessory may output the received content simultaneously.

### BACKGROUND

Accessories, such as earbuds and AR/VR headsets, may be wirelessly connected to multiple host devices, such as a laptop, smartphone, tablet, hub, etc. For example, a user may be wearing their earbuds to participate in a conference call streamed from their laptop. At the same time, a notification may come through from their smartphone. The earbuds may only be capable of playing audio from a single host device, even when connected to multiple devices. Therefore, the notification from the smartphone may pause, or interrupt, the audio from the conference call.

The accessory may switch a single receiver between multiple host transmitters when the accessory receives content from multiple host devices. The single receiver may be tuned to a single frequency and, therefore, may be able to only receive from a single host transmitter. The accessory may miss receiving packets being sent from a second host transmitter and, instead, may rely on the second host transmitter retransmitting the packets at a later time in order for the accessory to receive the packets from the second host transmitter. In some instances, the accessory may never receive the packets from the host second transmitter. This may lead to degraded link quality between the accessory and the second host device and, therefore, the output of content received from the second host device. When the content from the second host device is mixed with the content from the first host device, the output may be degraded providing a poor listening experience for the user.

### SUMMARY

The disclosure relates to a method, comprising establishing a first wireless communication interface with a first host device, the first wireless communication interface configured to receive a first content from the first host device or to transmit the first content to the first host device; establishing a second wireless communication interface with a second host device, the second wireless communication interface configured to receive a second content from a second host device or to transmit the second content to the second host device; determining: a first start time for transmission or receipt of the first content over the first wireless communication interface; and a second start time for transmission or receipt of the second content over the second wireless communication interface; comparing a difference between the first start time and the second start time to a threshold value; and adjusting, based on the difference being greater than the threshold value, the first start time, the second start time, or both start times such that the difference between the first start time and the second start time is below the threshold value. The first and the second start time may be determined based on parameters related to a connection via the first and the second wireless communication interface. For example, the method comprises identifying a type of a wireless connection between the first and/or the second wireless communications interface and their respective host devices, wherein the first and/or the second start time is determined based on the identified type of wireless connection. The first and the second wireless communication interface may belong to the same accessory.

The technology generally relates to an electronic accessory that may wirelessly connect to one or more host devices such that the accessory is able to receive content from two or more of the host devices at the same or substantially the same time. The accessory may include one or more wireless communication interfaces, such as Bluetooth radios. Each of the wireless communication interfaces may be a main radio, such that each of the wireless communications interfaces functions in an active state. In some examples, each of the wireless communications interfaces may be connected to one or more antennas. The one or more antennas may receive the content from each of the host devices. Each wireless communications interface may receive filtered content. For example, using a single antenna, after the content is received by the antenna, the content may be filtered by a passband filter such that only the content, in the form of packets, within a particular channel or frequency band will pass through the filter. In particular, the electronic accessory comprises two or more wireless communication interfaces configured to receive content from one or more host devices; a memory and one or more processors configured to execute determining: a first start time for transmission or receipt of the first content over the first wireless communication interface; and a second start time for transmission or receipt of the second content over the second wireless communication interface; comparing a difference between the first start time and the second start time to a threshold value; and adjusting, based on the difference being greater than the threshold value, the first start time, the second start time, or both start times such that the difference between the first start time and the second start time is below the threshold value. Embodiments of the accessory may include features described in conjunction with the disclosed method. For example, the one or more processors may be configured to identify a type of a wireless connection between the first and/or the second wireless communications interface and their respective host devices, wherein the first and/or the second start time is determined based on the identified type of the wireless connection. The first and the second wireless communication interface may belong to the same accessory.

In examples where the accessory is connected to a first and second host device (e.g., a first and a second wireless communication interface), a first and second piconet may exist. A piconet may be a group of devices connected via a wireless connection, such as Bluetooth. The first piconet may include the accessory and the first host device while the second piconet may include the accessory and the second host device.

The antenna may receive content from a first host device and a second host device simultaneously. In some examples, the timing of the first and second piconets receiving content, such as packets, may be aligned such that the accessory receives packets from and/or transmits packets to the first and second host devices at the same time. According to some examples, the timing of the first and second piconets may not be aligned. In such examples, the accessory may align the timing of the piconets using clock dragging. Additionally or alternatively, the accessory may use connection event anchor points to establish the timing of packet exchanges between the accessory and the first and second host devices. Connection event anchor points may be the time when the accessory and host device begin packet traffic. The packet traffic may continue through a connection event. In some examples, packet traffic may be completed before the end of the connection event. In some examples, the connection event anchor points may be the same. In some examples, the connection event anchor point may be aligned with a broadcast event anchor point. Broadcast event anchor points may be a time when the accessory begins receiving content from a broadcast device via a broadcast connection.

By aligning the timing of the piconets, aligning the piconets, or determining a timing of packet exchanges, the accessory may receive two or more packet streams via one or more antennas simultaneously. For example, each of the received two or more packets streams may be received from a separate transmitting device. Additionally or alternatively, the accessory may output the two or more packet streams, in the form of content, simultaneously. For example, the accessory may be a pair of earbuds, the first host device may be a laptop and the second host device may be a smartphone. The earbud antenna may receive both audio content associated with a conference call occurring on the laptop and an audio notification from the smartphone at the same time. In some examples, the earbuds may align the timing of the piconets such that the audio content associated with the conference call and the audio notification are received at the same time. The accessory may filter the content such that the audio content associated with the conference call is processed by a first piconet and the audio notification is processed by the second piconet. The earbuds may output the audio content associated with the conference call and the audio notification at the same time.

In some examples, the accessory may include two or more receivers and one or more transmitters. The receivers and transmitters may route the packets to one or more antennae. The transmitters, receivers, and antennae may be coordinated by a single controller. The controller may, for example, tune the receivers to the proper frequencies for a period of time, such as determined by the piconet. In some examples, the controller may schedule packets that are to be sent to each piconet. Additionally or alternatively, the controller may tune the transmitters to the proper frequency for the period of time to send the packets to the proper piconet.

An aspect of the disclosure includes an accessory comprising two or more wireless communications interfaces, including a first interface adapted to receive first content from a first host device and a second interface adapted to receive second content from a second host device, a memory, and one or more processors in communication with the memory and the two or more wireless communications interfaces. The one or more processors may be configured to identify a type of wireless connection between each of the two or more wireless communications interfaces and their respective host devices, determine, based on the types of wireless connections, a time for the accessory to simultaneously receive content from each of the first and second host devices or transmit content to each of the first and second host devices, and output the content received from each of the two or more host devices simultaneously.

The type of wireless connections may include a classic Bluetooth connection, a Bluetooth low energy connection, or a Bluetooth low energy broadcast connection. In examples where each of the types of wireless connections is a classic Bluetooth connection, when determining the time for the accessory to simultaneously receive content from each of the first and second host devices the one or more processors may be further configured to align a time slot boundary for each of the wireless connections. The one or more processors may be configured to apply clock dragging to align the time slot boundary for each of the wireless connections.

In examples where a first determined wireless connection is a classic Bluetooth connection and a second determined wireless connection is a Bluetooth low energy connection, when determining the time for the accessory to simultaneously receive content from each of the first and second host devices the one or more processors may be further configured to align a time slot boundary of the first determined wireless connection and a connection event anchor point of the second wireless connection. In some examples, where each of the types of wireless connections is a Bluetooth low energy connection, when determining the time for the accessory to simultaneously receive content from each of the first and second host devices the one or more processors may be further configured to align a connection event anchor point for each of the wireless connection.

The accessory may further comprise an antenna in communication with each of the two or more wireless communications interfaces and configured to receive the content from each of the first and second host devices. Each of the two or more wireless communications interfaces may be a Bluetooth radio.

Another aspect of the disclosure includes a method comprising identifying, by one or more processors in communication with two or more wireless communications interfaces, a type of wireless connection between each of the two or more wireless communications interfaces and their respective host devices, wherein the two or more wireless communications interfaces includes a first interface adapted to receive first content from a first host device and a second interface adapted to receive second content from a second host device, determining, by the one or more processors based on the types of wireless connections, a time for the accessory to simultaneously receive content from each of the first and second host devices or transmit content to each of the first and second host devices, and outputting the content received from each of the first and second host devices simultaneously.

Yet another aspect of the disclosure includes a non-transitory computer-readable medium storing instructions, which when executed by one or more processors, cause the one or more processors to determine: a first start time for transmission or receipt of the first content over the first wireless communication interface; and a second start time for transmission or receipt of the second content over the second wireless communication interface; compare a difference between the first start time and the second start time to a threshold value; and adjust, based on the difference being greater than the threshold value, the first start time, the second start time, or both start times such that the difference between the first start time and the second start time is below the threshold value. For example, the instructions cause the one or more processors to identify a type of wireless connection between each of two or more wireless communications interfaces and their respective host devices, wherein the two or more wireless communications interfaces includes a first interface adapted to receive first content from a first host device and a second interface adapted to receive second content from a second host device, determine, based on the types of wireless connections, a time for the accessory to simultaneously receive content from each of the first and second host devices or transmit content to each of the first and second e host devices, and output the content received from each of the first and second host devices simultaneously.

### BRIEF DESCRIPTION OF THE DRAWINGS

FIG. 1 is a pictorial diagram of an example system according to aspects of the disclosure.

FIG. 2 is a functional block diagram of an example system according to aspects of the disclosure.

FIG. 3 is a functional diagram of an example accessory according to aspects of the disclosure.

FIG. 4 illustrates an example alignment of communications across piconets according to aspects of the disclosure.

FIG. 5 is a timing diagram illustrating connection event air time according to aspects of the disclosure.

FIG. 6 illustrates another example alignment of communications across piconets according to aspects of the disclosure.

FIG. 7 illustrates another example alignment of communications across piconets according to aspects of the disclosure.

FIG. 8 illustrates another example alignment of communications across piconets according to aspects of the disclosure.

FIG. 9 illustrates another example alignment of communications across piconets according to aspects of the disclosure.

FIG. 10 is a flow diagram illustrating an example method of aligning communications across piconets according to aspects of the disclosure.

### DETAILED DESCRIPTION

The technology relates generally to an accessory that may be wirelessly connected to one or more host devices such that the accessory is able to receive content from two or more of the host devices at the same or substantially the same time. An accessory may be used to refer to any electronic device that is coupled to a host device and capable of providing information in some form, such as audio, visual, haptic feedback, etc., to a user. Examples of accessories include earbuds, hearing aids, smartwatches, headsets, other wearable electronics, etc. Examples of host devices include smartphones, laptops, hubs, tablets, gaming consoles, home assistant devices, etc.

The content may be any audible and/or visual media, such as video, images, music content, a short notification, a ringtone notification, audio associated with visual content, a broadcast notification, etc. Audible media, such as audio content, may be continual audio content having at least a predetermined number of bits for transmission. Additionally or alternatively, audio content may be continual audio content requiring a predetermined bandwidth to prevent packet loss. A short notification may be, for example, a “ping” or “ding” to direct a user's attention to the accessory or to alert the user of a notification. In some examples a broadcast notification may be a notification that is transmitted by a broadcast device. For example, a broadcast notification may be a notification that is broadcast to one or more devices such as an airport notification that is broadcast to all devices capable of receiving a Bluetooth Low Energy (“BLE”) broadcast notification. According to some examples, the accessory may receive the content in the form of packets.

The accessory may include one or more wireless communications interfaces, such as a Bluetooth radio. The accessory may be wirelessly coupled to the host devices via the wireless communications interfaces. For example, the wireless connection between the accessory and each of the host devices may be a Bluetooth connection, such as a classic Bluetooth connection and/or a BLE connection. Classic Bluetooth connections may use time slots for determining when to transmit and/or receive packets. A BLE connection may be a BLE for audio connection. In some examples, a BLE for audio connection may be a unicast BLE connection or a broadcast BLE connection. A unicast BLE connection may be a point-to-point connection between an accessory and a host device. A broadcast BLE connection may be a host device that is capable of broadcasting content to one or more accessories.

The accessory may receive and/or transmit content via each wireless, or Bluetooth, connection. In some examples, the accessory may align when packets are received and/or transmitted over each Bluetooth connection. The alignment of receiving and/or transmitting packets may depend on the types of Bluetooth connections between the accessory and the two or more host devices.

For example, when the accessory is connected to two host devices, two piconets may exist. A first piconet may include the accessory and a first host device and a second piconet may include the accessory and a second host device. When the two wireless communication interfaces within the accessory operate simultaneously, the piconet time slots may be aligned to prevent interference between the accessory and the two host devices. The first and second piconet time slots may be aligned when the accessory receives data packets from both the first and second host devices at the same time or substantially the same time. Additionally or alternatively, aligning the first and second piconet slots may include transmitting, by the accessory, data packets to both the first and second host devices at the same time. The accessory may receive data packets from the first and second host devices at the same time as first packets received from the first host device may be received on a first wireless communication channel while second packets received from the second host device may be received on a second wireless communication channel. In some examples, the accessory may include one or more antennas. The one or more antennas may receive the content from the first and second host devices. The accessory and/or each wireless communication interface may filter the first and second packets such that each wireless communication interface will allow the packets corresponding to the respective channel to proceed to processing. Once the packets are processed, the packets may be output through the accessory in the form of content, such as audio content through a speaker.

According to some examples, the timing of the first and second piconets may not be aligned. For example, each of the wireless communication interfaces may be a classic Bluetooth radio. Each classic Bluetooth radio may include a time slot boundary. The time slot boundary may be the start time of a period of time during which the Bluetooth radio may receive and/or transmit packets. In such an example, the accessory may use clock dragging technology to align the time slots such that the accessory receives and/or transmits packets to the first and second host devices at the same time. Clock dragging technology may align the time slot boundary. For a classic Bluetooth connection, the time slot may be fixed. Clock dragging technology may align the slot boundary of each piconet. Clock dragging adjusts the length of a connection time slot in order to affect the phase of a clock backward or forward. By way of example only, if two, classic Bluetooth connection time slots are misaligned, one of the time slots may be shortened or lengthened by a small amount in order to align the time slot start times. In some examples, a packet may be transmitted during the time slot but may not use the entire time slot. In such an example, no other packet traffic may occur during the remainder of the time slot. In some examples, a first one of the wireless communication interfaces may be a classic Bluetooth radio and a second wireless communications interface may be a BLE radio. In such an example, the BLE radio may determine a connection event anchor point to start the packet exchange between the accessory and the host device. The accessory may align the connection event anchor point with the time slot of the classic Bluetooth connection. The accessory may begin receiving packets from the first and second host devices when the connection event anchor point is aligned with the time slot of the classic Bluetooth connection. In some examples, the BLE packet airtime may be less than the classic Bluetooth packet airtime. In examples where the BLE packet airtime is smaller, the accessory may continue to receive packets from and/or transmit packets to the second host device until the BLE packet traffic finishes. According to some examples, as the accessory receives packets from or transmits packets to the second host device, the accessory may be interrupted from receiving packets from the first host device. In such an example, the accessory may send a message to the first host device asking for the first host device to retransmit the missed packets. The accessory may receive the retransmitted packets after the BLE packet traffic is complete.

In one example, the accessory may be wirelessly connected to each host device via a BLE connection. In such an example, the accessory may negotiate the connection event anchor points to be the same for each of the host devices such that the packet traffic is aligned for both wireless connections. In some examples, the time it takes to receive and transmit packets over a first BLE connection may be less than the time it takes to receive and transmit packets over a second BLE connection. The accessory may prioritize receiving and transmitting the packets that take the least amount of time. For example, the accessory may prioritize receiving and transmitting the packets via the first BLE connection. After the shorter packet traffic is completed via the first BLE connection, the longer packet traffic may be completed via the second BLE connection through retransmission. According to some examples, the longer packet traffic may be completed via the second BLE connection in a subsequent connection event.

In another example, the accessory may be connected to a first host device via a classic Bluetooth connection and a second host device via a BLE broadcast connection. The accessory may align the time slot of the classic Bluetooth connection with the broadcast event anchor point of the BLE broadcast connection. By aligning the time slot and the broadcast event anchor point, the opportunity for the accessory to simultaneously receive packets from the first and second host devices may increase. In some examples, subsequent to the initial alignment of the time slot and the broadcast event anchor point, the accessory may not be able to align the time slot and the broadcast event packet length. In examples where the time slot and the broadcast event anchor point cannot be aligned, the accessory may prioritize receiving packets from the second host device via the BLE broadcast connection such that when the accessory is receiving packets from the second host device, the accessory may not receive packets from the first host device. The accessory may transmit a message to the first host device for the host device to retransmit the packets after the BLE broadcast traffic is complete.

In some examples, the accessory may be connected to a first host device via a BLE connection and a second host device via a BLE broadcast connection. The accessory may align the time connection event anchor point for the BLE connection with the broadcast event anchor point of the BLE broadcast connection. By aligning connection event anchor point and the broadcast event anchor point, the opportunity for the accessory to simultaneously receive packets from the first and second host devices may increase. The packet traffic over the BLE broadcast connection may be prioritized over the packet traffic over the BLE connection. The accessory may have a limited opportunity to receive packet traffic over the BLE broadcast connection as the broadcast host may stop transmitting the packets in order to switch to the next broadcasting event. After the accessory receives the packets over the BLE broadcast connection, the antenna and airtime priority may return to the BLE connection between the accessory and the first host device.

### Example Systems

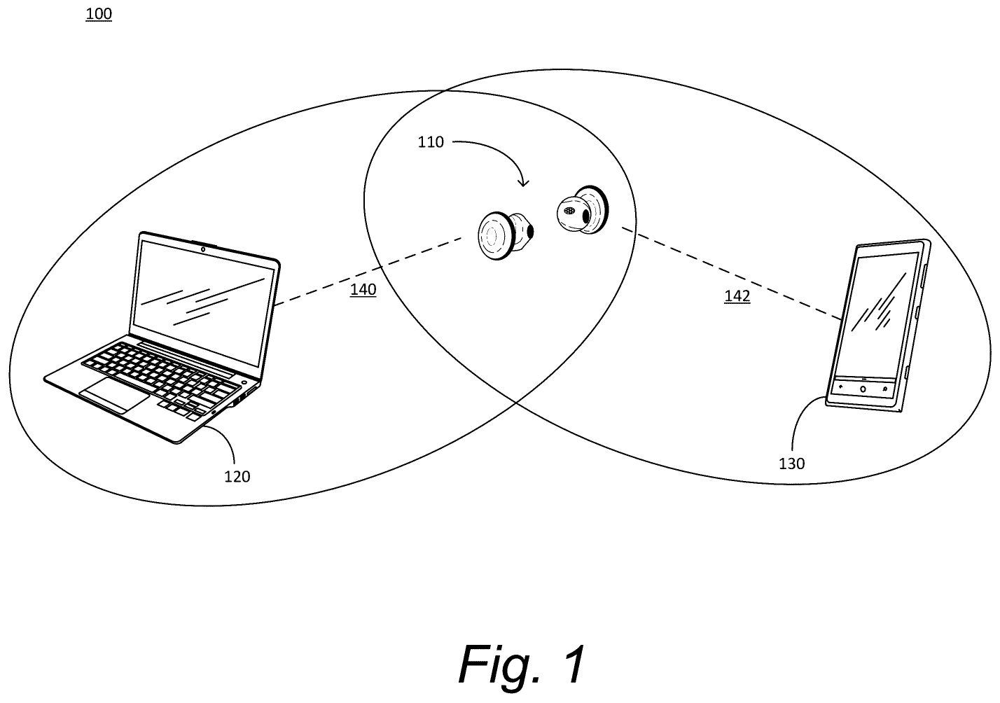

FIG. 1 illustrates an example system 100 in which the features described herein may be implemented. It should not be considered limiting the scope of the disclosure or usefulness of the features described herein. In this example, system 100 may include an accessory 110 and host devices 120, 130. The accessory may be a pair of wireless earbuds 110 and the host devices may be a laptop 120 and smartphone 130. In some examples, the accessory may be an AR/VR headset and the host devices may include a hub and tablet. The system 100 may be a fully wireless system, including two piconets. The first piconet includes host device 120 and accessory 110. The second piconet includes host device 130 and accessory 110.

Accessory 110 and host devices 120, 130 may each be a personal computing device intended for use having all of the components normally used in connection with a personal computing device, as described herein, including a one or more processors (e.g., a central processing unit (CPU)), memory (e.g., RAM and internal hard drives) storing data and instructions, a display (e.g., a monitor having a screen, a touch-screen, a projector, a television, or other devices such as a smartwatch display that is operable to display information), and user input devices (e.g., a mouse, keyboard, touchscreen or microphone). According to some examples, accessory 110 and host devices 120, 130 may each be a mobile computing device capable of wirelessly exchanging data with a server over a network such as the Internet, or a full-sized personal computing device.

In some examples, host devices 120, 130 may be wirelessly coupled to accessory 110. As shown, host device 120 may be wirelessly coupled to accessory 110 via wireless connection 140 and host device 130 may be wirelessly coupled to accessory 110 via wireless connection 142.

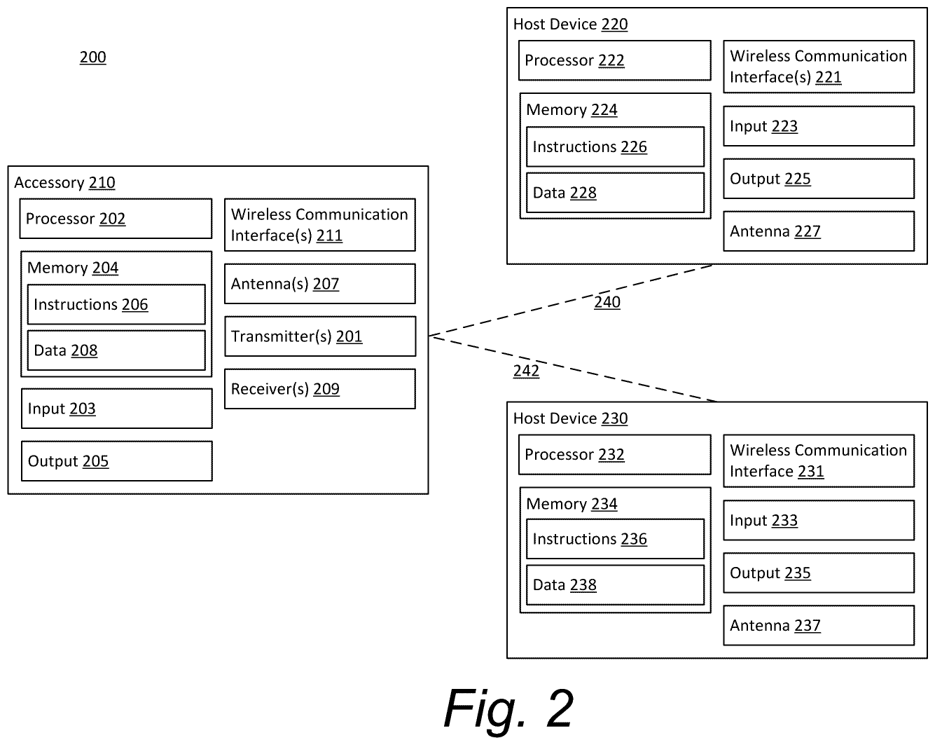

FIG. 2 illustrates an example system 200 in which the features described above and herein may be implemented. It should not be considered as limiting the scope of the disclosure or usefulness of the features described herein. In this example, the system 200 may include accessory 210 and host devices 220, 230. Accessory 210 may contain one or more processors 202, memory 204, instructions 206, data 208, a wireless communication interface 211, input 203, and output 205. The accessory 210 may be able to communicate with host devices 220, 230 via a short-range wireless communication interface.

The one or more processors 202 may be any conventional processors, such as commercially available microprocessors. Alternatively, the one or more processors may be a dedicated device such as an application specific integrated circuit (ASIC) or other hardware-based processor. Although FIG. 2 functionally illustrates the processor, memory, and other elements of accessory 210 as being within the same block, it will be understood by those of ordinary skill in the art that the processor, computing device, or memory may include multiple processors, computing devices, or memories that may or may not be stored within the same physical housing. Similarly, the memory may be a hard drive or other storage media located in a housing different from that of accessory 210. Accordingly, references to a processor or computing device will be understood to include references to a collection of processors or computing devices or memories that may or may not operate in parallel.

Memory 204 may store information that is accessible by the processors, including instructions 206 that may be executed by the processors 202, and data 208. The memory 204 may be any type of memory operative to store information accessible by the processors 202, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 206 and data 208 are stored on different types of media.

Data 208 may be retrieved, stored or modified by processors 202 in accordance with the instructions 206. For instance, although the present disclosure is not limited by a particular data structure, the data 208 may be stored in computer registers, in a relational database as a table having a plurality of different fields and records, XML documents, or flat files. The data 208 may also be formatted in a computer-readable format such as, but not limited to, binary values, ASCII or Unicode. By further way of example only, the data 208 may be stored as bitmaps comprised of pixels that are stored in compressed or uncompressed, or various image formats (e.g., JPEG), vector-based formats (e.g., SVG), or computer instructions for drawing graphics. Moreover, the data 208 may comprise information sufficient to identify the relevant information, such as numbers, descriptive text, proprietary codes, pointers, references to data stored in other memories (including other network locations), or information that is used by a function to calculate the relevant data.

The instructions 206 can be any set of instructions to be executed directly, such as machine code, or indirectly, such as scripts, by the processor 202. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The accessory 210 may further include one or more wireless communication interfaces 211, such as a transceiver, Bluetooth radio, and any other devices used for wireless communication. Additionally or alternatively, the accessory 210 may include one or more antennas 207. The antenna 207 may be, for example, a short-range wireless network antenna. In some examples, an accessory with a small form factor, such as earbuds, may have a single antenna while an accessory with a larger form factor, such as a hub, may have two or more antennas.

The accessory may include one or more transmitters 201 and receivers 209. The receiver 209 may include one or more receiving blocks. The transmitter 201 may include one or more transmitting blocks. The antenna 207, transmitters 201, and receivers 209 may be coordinated by a single link controller. According to some examples, the antenna 207 may be switched by the controller in a time-multiplexed fashion between the radio-frequency (“RF”) inputs of the receiving blocks and the RF output of the transmitting block. In some examples, each receiving block may be tuned and hopping in synchronization to the piconet established by a host device's wireless communication interface. For example, the accessory may tune the RF blocks to the frequency channel such that the accessory can transmit or receive packet traffic. According to some examples, the receiver may automatically change the Bluetooth channel for each packet that the accessory transmits. The accessory may automatically change the Bluetooth channel based on predefined rules. In such an example, each receiving block may receive signals from the associated transmitter, even when multiple host devices are transmitting content simultaneously.

In some examples, accessory 210 may include an antenna 207 for each receiver 209. Additionally or alternatively, accessory 210 may include a single antenna 207 for multiple receivers 209. In such an example, the transmitting packets may be scheduled sequentially such that the transmission of the packets may occur at a time after the receivers 209 have completed receiving their packets. The transmission packets may be transmitted over the air on a single transmission block and/or multiple transmission blocks simultaneously or in a time interleaved fashion. This may prevent desensitizing the receivers 209.

Desensitizing the receivers, or signal desensitization, may occur when the accessory cannot filter a desired signal. For example, if a first wireless communications interface is transmitting packets at the same time a second wireless communications interface is receiving packets, the transmission signal may be picked up by the receiving RF chain. If two or more antennas are used and positioned close to each other, the receiving wireless communications interface may receive both the desired packets and the undesired transmission signal from the wireless communications interface nearby. In some examples where the two wireless communications interfaces are close, the receiving wireless communications interface may pick up, or receive, the unintended signal as a strong signal (e.g., the transmission signal) as well as the desired signal (e.g., the receiving signal) from a host device. According to some examples, when the accessory cannot filter the desired signal, signal desensitization may occur.

According to some examples, the accessory 210 may miss the window, or time slot, for sending an acknowledgement to the host device. In such an example, the host device may retransmit the packets and/or the host device may mark the packets as dropped. In both examples, the accessory 210 may have, nonetheless, received the packet and output the content associated with the packet.

The accessory 210 may be wirelessly coupled to host devices 220, 230 via wireless connections 240, 242, respectively. For instance, the wireless communication interface 211 and/or antenna 207 may be used to transmit and receive Bluetooth signals. There may be a maximum distance between accessory 210 and host devices 220, 230 that would allow accessory 210 and host devices 220, 230 to be within range of each other.

Accessory 210 may further include an input 203. The input 203 may be, for example, a touch sensor, dial, button, or other control for receiving a manual command. The input 203 may, in some examples, be a microphone. The accessory 210 may also include an output 205. The output 205 may be, for example, a speaker.

Host devices 220, 230 may each include one or more processors 222, 232, memory 224, 234, wireless communication interface 221, 231, input 223, 233, output 225, 235, antenna 227, 237, transmitters, and receivers, respectively, that are substantially similar to those described herein with respect to accessory 210.

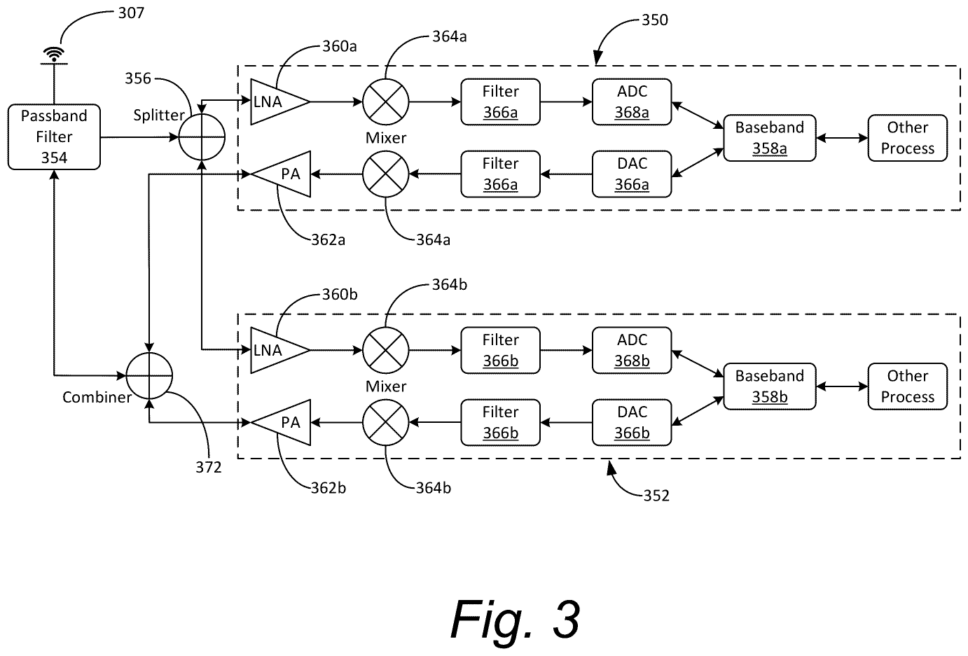

FIG. 3 illustrates an example system architecture for an accessory wirelessly connected to two host devices. Each of the wireless connections may be a type of Bluetooth connection. For example, the Bluetooth connection may be a classic Bluetooth connection or a BLE for audio connection. A classic Bluetooth connection may be a point-to-point connection such that there is a one to one match between the accessory and a host device. A BLE for audio connection may be a unicast BLE connection or a broadcast BLE connection. A unicast BLE connection may be a point-to-point connection between an accessory and a host device. A broadcast BLE connection may be a host device connected to one or more accessories. A BLE host device may broadcast information such that any accessory with a BLE radio may receive the information.

In some examples, when the accessory is wirelessly coupled to the first and second host devices, the accessory and the respective host device may form a piconet. A piconet may be, for example, a group of devices that are connected via a Bluetooth connection and/or any wireless connection. As shown in FIG. 3, there may be two piconets 350, 352 when the accessory is connected to two host devices. According to some examples, each piconet may have its own RF system. The RF system may include, for example, one or more passband filters 354, splitters 356, combiners 372, low noise amplifiers 360a, 360b, power amplifiers 362a, 362b, mixers 364a, 364b, filters 366a, 366b, analog to digital converters (“ADC”) 368a, 368b, digital to analog converters (“DAC”) 370a, 370b, and/or basebands 358a, 358b.

Antenna 307 of the accessory may receive content, in the form of packets, from the first and second host devices. The content may pass through passband filter 354. Passband filter 354 may allow for packets within a range of frequencies to pass through. The range of frequencies may correspond to the frequencies of each of the wireless communication interfaces. After the packets passes through passband filter 354, the packets may be split by splitter 356. Splitter 356 may separate the packets based on frequency. For example, the packets may be received by antenna 307 on different channels which reside on different frequencies. The splitter 356 will direct the packets on a certain frequency to the piconet 350, 352 associated with that frequency. Once the packets are within the piconet 350, 352, the packets may be sent to the respective baseband 358a, 358b to be processed for output.

In some examples, accessory 310 may transmit content in the form of packets. The packets may be processed by piconet 350, 352 to be transmitted to a respective host device. The packets may be combined by combiner 372 to be transmitted by antenna 306 to the host devices.

### Example Alignments

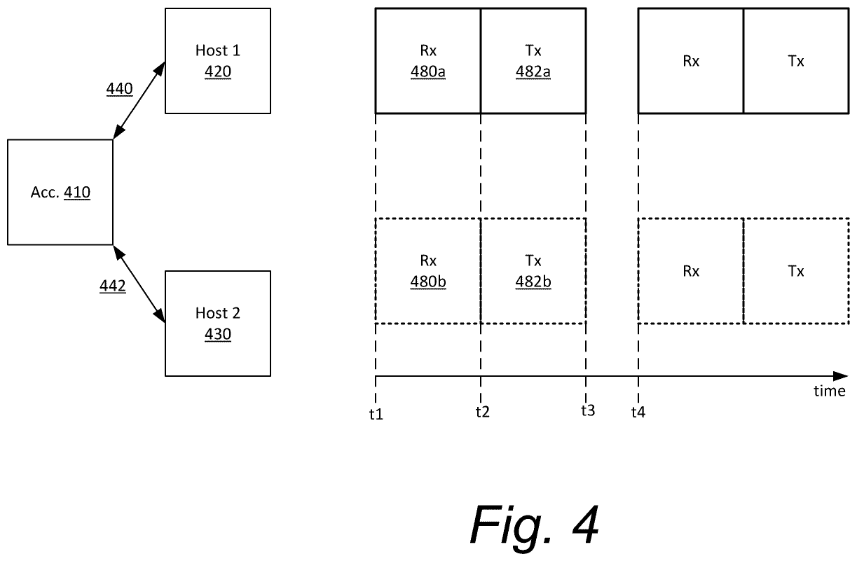

FIG. 4 illustrates an example alignment of communications across piconets in which the time slots of each of the two piconets are fully aligned. For example, an accessory 410 may be wirelessly coupled to a first host device 420 and a second host device 430. The accessory 410 may receive packets from both the first host device 420 and second host device 430 at the same time. For example, the accessory 410 may receive 480a packets from first host device 420 and receive packets 480b from second host device 430 at time t1. Time t1 may be the boundary of the time slot. Additionally or alternatively, the accessory 410 may transmit packets to the first host device 420 and smartphone 430 at the same time. As shown in FIG. 4, at time t2, the accessory may transmit packets 482a to first host device 420 via wireless connection 440 and transmit packets 482b to second host device 430 via wireless connection 442. By aligning the piconet time slots such that the accessory transmits packets to and receives packets from each of the host devices simultaneously, the accessory may output the packets, in the form of content, simultaneously.

In some examples, the antenna within accessory 410 may receive the signal, or packets, from first host device 420 and second host device 430 simultaneously. According to some examples, the Bluetooth connection may have a frequency hopping mechanism such that the accessory 410 may receive packets from the first host device 420 on a first frequency and packet from the second host device 430 on a second frequency. Frequency hopping may be, for example, when a first packet(s) is transmitted on a first frequency channel of the Bluetooth connection and the Bluetooth connection may subsequently use a second frequency channel to exchange the packet(s). As the packets are received by the antenna, the accessory 410 and/or each wireless communications interface within the accessory 410 may filter the packets to be processed by a respective RF system. In some examples, the packets may be filtered such that only the packets within the channel or frequency of a particular wireless communications interface remain. Once the packets are filtered, the wireless communications interface may send the packets to a respective baseband within the RF system for further processing prior to output.

According to some examples, when each wireless communications interface on the accessory transmits packets to one or more host devices, the baseband packets may be modulated to a predetermined channel, or frequency. The packets, or signal, may be mixed by a combiner prior to the antenna transmitting the packets to the host devices.

In one example, the accessory may be wirelessly coupled to a first and second host device, in particular via a first and a second wireless communication interface. The wireless connection between the accessory and each of the first and second host devices may be a classic Bluetooth connection. Classic Bluetooth connections may use time slots for determining when to transmit and/or receive packets. According to some examples, the accessory may use clock dragging technology to align the slot timing for the first and second host devices. For example, the accessory may adjust the phase of the clock to make the time slots either longer or shorter until the time slots for each of the host devices are aligned. The accessory may align the slot times of the first and second wireless connections such that the accessory receives packets from and transmits packets to each of the host devices at the same time. For example, the accessory determines a first and a second start time for transmission or receipt of content over the first and second wireless communication interface (e.g., depending on the type of the wireless connections), respectively, compares a difference between the first start time and the second start time to a threshold value and adjusts, based on the difference being greater than the threshold value, the first start time, the second start time, or both start times such that the difference between the first start time and the second start time is below the threshold value. Adjusting the first and the second start time may be performed by adjusting the phase of the clock and/or aligning the slot times of the first and second wireless connection as described above. According to some examples, after the accessory aligns the slot times, the accessory may filter the packets to be processed by a respective RF system within the accessory. For example, the passband filter may filter any packets that are outside of the predetermined channels and/or frequency range. The remaining packets may be directed to the proper RF system via a splitter. For example, packets within a first channel or frequency range may be directed to a first RF system for processing while packets within a second channel or frequency range may be directed to a second RF system for processing.

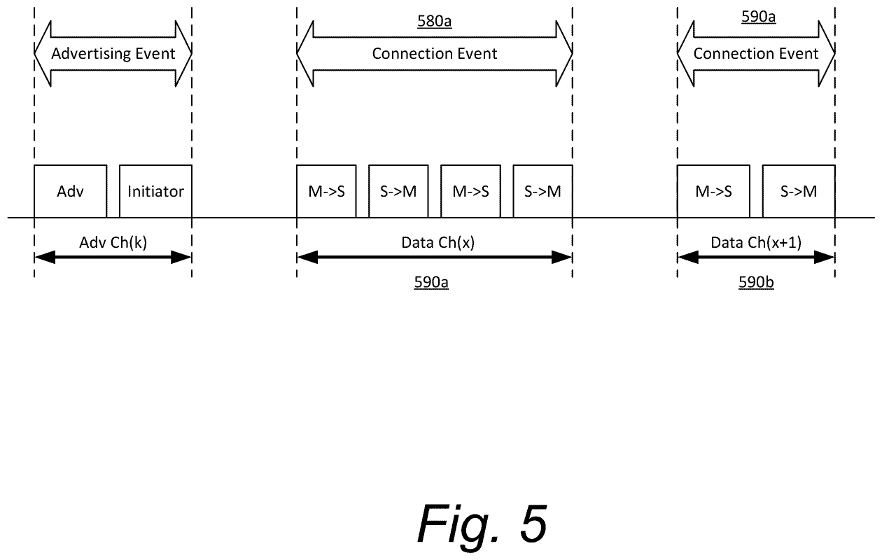

FIG. 5 illustrates an example timing for receiving and/or transmitting packets. For example, an accessory may be wirelessly coupled to two host devices. The wireless connection between the accessory and the first host device may be a classic Bluetooth connection and the wireless connection between the accessory and the second host device may be a BLE connection. In some examples, the classic Bluetooth connection may have time slots, or slot boundaries. Additionally or alternatively, the BLE connection may have a connection event anchor point. The connection event anchor point may be the start of the packet exchange between the accessory and the host device.

According to some examples, the BLE connection event anchor point may initiate the packet exchange between the host device and the accessory. In examples where the packet exchange occurs within the negotiated connection window, the packets may be transmitted multiple times. For example, the accessory may receive packets during a first connection event 580a from a first data channel 590a. In some examples, if the accessory fails to receive a packet and/or when two consecutive packets are received by the accessory with an invalid cyclic redundancy check (“CRC”) match during the connection event, the connection event may close. In examples where the connection even closes, a packet that was not received by the accessory may not be received until the next connection anchor point. In some examples, the next connection anchor point may be connection event 580b on second data channel 590b and/or a subsequent connection event.

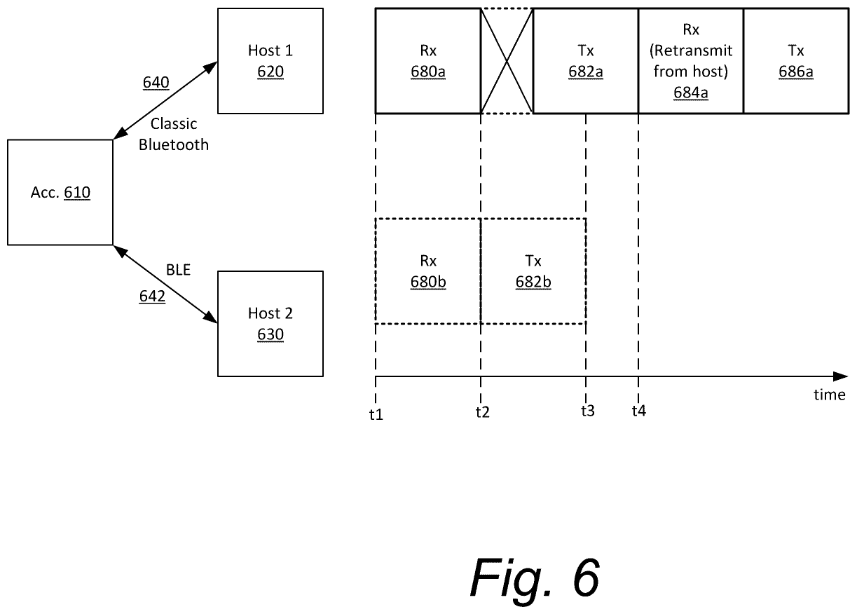

FIG. 6 illustrates another example timing for receiving and/or transmitting packets. For example, the accessory 610 may be wirelessly connected to the first host device 620 via a classic Bluetooth connection 640 and wirelessly connected to the second host device 630 via a BLE connection 642. In some examples, the accessory 610 may align the BLE connection event anchor point with the classic Bluetooth time slot such that the accessory 610 receives packets from both the first and second host devices at the same time. In some examples, the accessory 610 may align the connection event anchor point and the time slot boundary when the wireless connections 640, 642 between the accessory 610 and the first and second host devices 620, 630 are established.

According to some examples, the accessory 610 may align the connection event anchor point and the time slot boundary at time t1. The accessory 610 may begin to receive packets 680a, 680b from the first and second host devices 620, 630, respectively. The accessory 610 may transmit 682b packets to the second host device 630 after the switch from receiving 680b to transmitting 682b at time t2. The accessory 610 may transmit 682b packets to the second host device 630 after the accessory finishes receiving 680b from the second host device.

In some examples, the BLE packet airtime for receiving 680b and transmitting 682b may be smaller, or shorter in duration, than the classic Bluetooth packet airtime for receiving 680a and transmitting 682a. For example, when the accessory 610 attempts to transmit 682b packets to the second host device 630, the accessory 610 may still be receiving or trying to receive 680a packets from the first host device 620. The transmission of packets 682b from the accessory 610 to the second host device 630 may interrupt the accessory 610 from receiving packets 680a from the first host device 620. The accessory 610 may continue transmitting packets 682b to the second host device 630 while simultaneously receiving a packet receiving error from the packets attempted to be received 680a from the first host device 620. According to some examples, the accessory 610 may send a message to the first host device 620 requesting the packets that could not be received 680a from the first host device 620 to be retransmitted. The accessory 610 may complete receiving 680b packets from and transmitting 682b packets to the second host device at time t3. The accessory 610 may receive and transmit the retransmitted packets 684a and 686a at time t4, which may be after time t3.

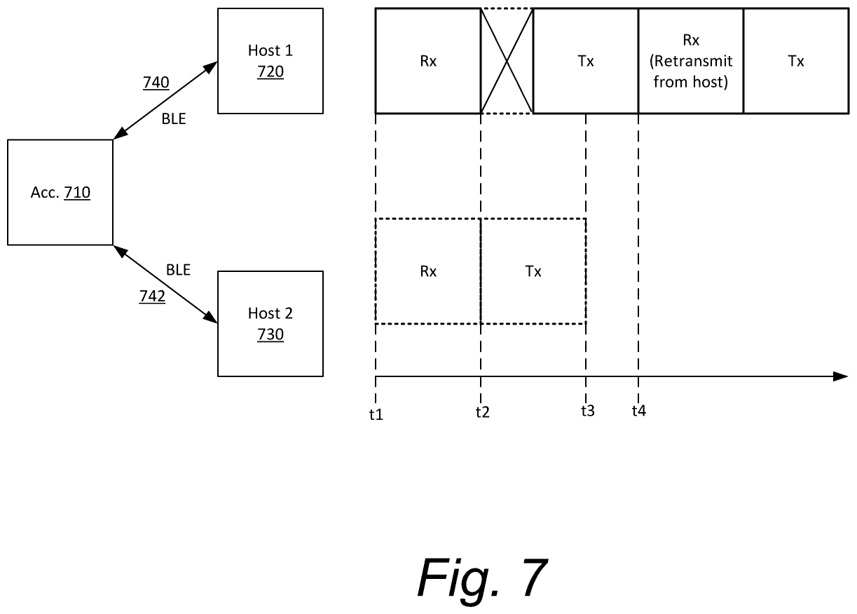

FIG. 7 illustrates another example timing for receiving and/or transmitting packets. For example, the accessory 710 may be wirelessly connected to each of the first and second host devices 720, 730 via a BLE connection 740, 742. In some examples, the accessory 710 may align the first BLE connection event anchor point of the first BLE connection 740 with the second BLE connection event anchor point of the second BLE connection 742 such that the accessory 710 receives packets from both the first and second host devices at the same time.

According to some examples, the time it takes the accessory 710 to receive and transmit packets via BLE connection 742 may be less than the time it takes the accessory 710 to receive and transmit packets via BLE connection 740. The accessory 710 may prioritize the packet traffic via BLE connection 742. That is, the accessory 710 may prioritize the packet traffic with the shortest packet airtime. By prioritizing the packet traffic via BLE connection 742, the packet traffic via BLE connection 740 may be delayed to the next connection event. For example, after the accessory 710 finishes receiving and transmitting packets via BLE connection 742, the first connection event may be complete. In a next, or subsequent, connection even, the accessory 710 may prioritize receiving and transmitting via BLE connection 740.

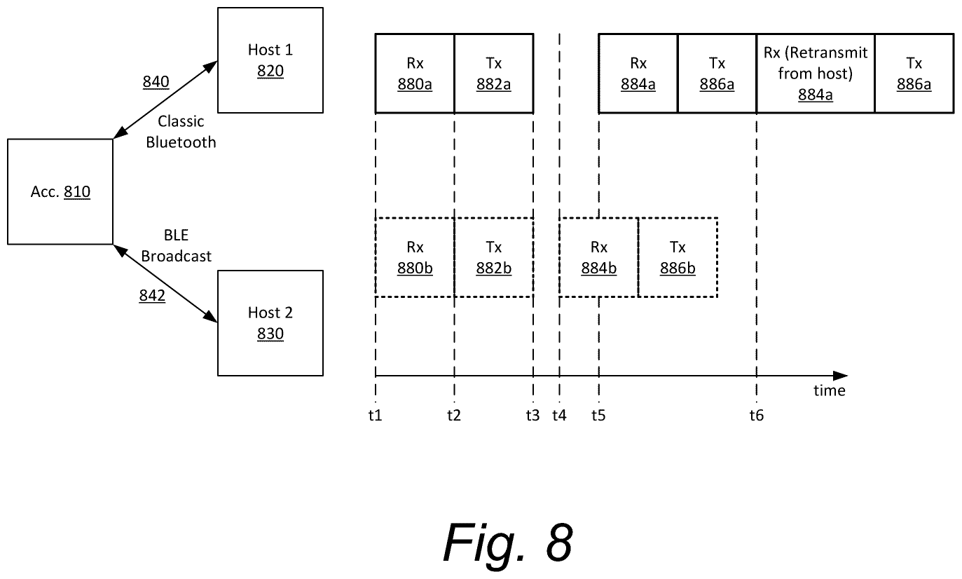

FIG. 8 illustrates another example timing for receiving and/or transmitting packets. For example, the accessory 810 may be wirelessly connected to a first host device 820 via a classic Bluetooth connection 840 and to a second host device 830 via a BLE broadcast connection 842 at time t1. The accessory 810 may receive 880a, 880b packets from first host device 820 and second host device 830 simultaneously. In some examples, the accessory 810 may align the time slot of the classic Bluetooth connection 840 with the broadcast connection anchor event of the BLE broadcast connection 842. Subsequent to aligning the time slot and the broadcast connection anchor event, the accessory may receive 884a, 884b additional packets from the first and second host devices 820, 830. As shown in FIG. 8, the time slot may begin at time t5 while the broadcast connection event anchor may be at time t4. In some examples, when the accessory 810 receives the subsequent packets, the accessory 810 may not be able to align the time slot of the classic Bluetooth connection 840 and the broadcast connection anchor point of the BLE broadcast connection 842. In examples where the time slot and the broadcast connection anchor point cannot be aligned, the accessory may prioritize receiving 884b the packets via the BLE broadcast connection 842. In such an example, the accessory 810 may not receive 884a the packets via the classic Bluetooth connection 840 when the BLE broadcast connection 842 is prioritized.

According to some examples, classic Bluetooth connection 840 may use a retransmission mechanism to increase the packet reception chance. For example, when the accessory 810 refuses and/or fails to receive packets from first host device 820 via the classic Bluetooth connection 840, the first host device 820 may retransmit 884a the packets until accessory 810 receives them.

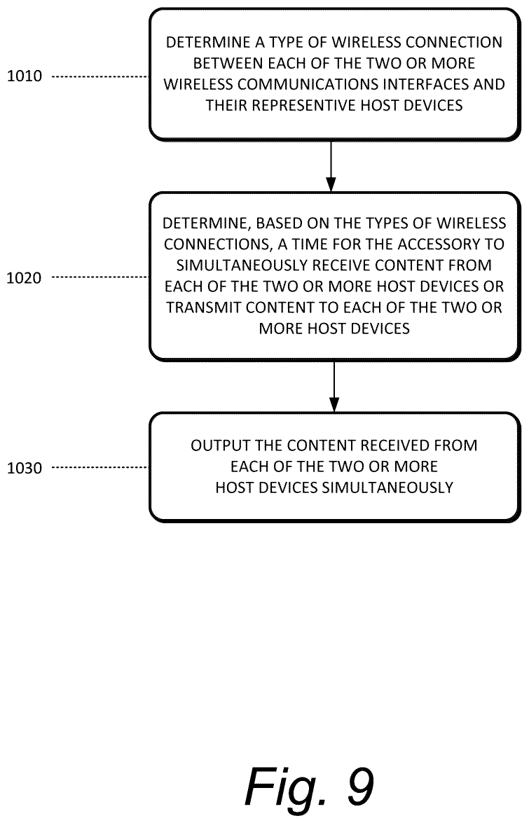

FIG. 9 illustrates another example timing for receiving and/or transmitting packets. For example, the accessory 910 may be wirelessly connected to a first host device 920 via a BLE connection 940 and to a second host device 930 via a BLE broadcast connection 942. The second host device 930 may be a broadcast host device. The accessory 910 may align the connection event anchor point of the Bluetooth connection 940 with the broadcast connection anchor point of the BLE broadcast connection 942 at time t1. Aligning the connection event anchor point of the Bluetooth connection 940 with the broadcast connection anchor point of the BLE broadcast connection 942 may increase and/or maximize the opportunity for the accessory 910 to receive content from both the first and second host devices 920, 930 simultaneously.

In some examples, packet traffic on BLE broadcast 942 subsequent to the alignment of connection event anchor point of the Bluetooth connection 940 with the broadcast connection anchor point of the BLE broadcast connection 942 may be prioritized over packet traffic on BLE connection 940. Packet traffic on BLE broadcast connection 942 may be prioritized as there may be a limited opportunity for the accessory 910 to receive the packets before the second host device 930 stops transmitting the packet. When packet traffic on the BLE broadcast connection 942 is prioritized, there may not be any packet traffic via BLE connection 940.

In some examples, after accessory 910 receives the broadcast message, in the form of packets, from second host device 930 via BLE broadcast connection 942, the accessory may prioritize the antenna and airtime for the BLE connection 940.

According to some examples, when accessory 910 is within a connection event with second host device 930, the accessory 910 may not be able to receive packets via BLE connection 940 from the first host device 920. Within each connection event, there may be rules for transmitting or receiving packet traffic. For example, if within the connection event, a packet from either side of connection (e.g., first host device 920 or accessory 910) is not received by the other party or two packet receiving errors occur, the connection event may be closed. In such an example, the packets being transmitted to the accessory 910 via BLE connection 940 may have to be retransmitted during a subsequent connection event in order for the accessory 910 to receive them. In some examples, the packets that are retransmitted via BLE connection 940 may be prioritized higher than the BLE broadcast connection 942. By prioritizing the packets being retransmitted via BLE connection 940, accessory 910 may receive the packets without being interrupted by packets being transmitted via BLE broadcast connection 942. In some examples, after accessory 910 receives the retransmitted packets via BLE connection 940, the accessory 910 may reprioritize the BLE broadcast connection 942. By reprioritizing the BLE broadcast connection 942, the accessory 910 may ensure it receives the greatest number of packet traffic via the BLE broadcast connection 942.

In some examples, the accessory 910 may apply a dynamic arbitration rule between the BLE connection 940 and the BLE broadcast connection 942. For example, if the accessory 910 continuously receives packets from the second host device 930 via the BLE broadcast connection 942 such that the accessory 910 cannot receive packets from the first host device 920 via the BLE connection 940, the BLE connection 940 may receive credits. The longer the accessory 910 does not receive packets from the first host device via the BLE connection 940 due to the BLE broadcast connection 942, the more credits the BLE connection 940 may receive. After accumulating a threshold number of credits, the accessory may prioritize the BLE connection 940 such that the accessory 910 receives packets via the BLE connection 940. After the accessory 910 receives the packets from the first host device 920, the accessory 910 may reprioritize the BLE broadcast connection 942. In some examples, after accessory 910 receives the packets from the first host device 920, the accessory 910 may remain the prioritized connection.

### Example Methods

FIG. 10 illustrates an example method for receiving content simultaneously from two or more host devices. The following operations do not have to be performed in the precise order described below. Rather, various operations can be handled in a different order or simultaneously, and operations may be added or omitted.

In block 1010, an accessory may identify a type of wireless connection between each of the two or more wireless communications interfaces and their respective host devices. The type of wireless connection between each of the two or more wireless communications interfaces and their respective host devices may be determined during the connection discovery phase when the accessory and host device are wirelessly coupled. According to some examples, the type of connection may be determined based on Bluetooth standard defined protocols. For example, the accessory may include a first interface adapted to receive first content from a first host device and a second interface adapted to receive second content from a second host device. According to some examples, the type of wireless connections include a classic Bluetooth connection, a Bluetooth low energy connection, or a Bluetooth low energy broadcast connection.

In block 1020, the accessory may determine, based on the types of wireless connections, a time for the accessory to simultaneously receive content from each of the two or more host devices or transmit content to each of the two or more host devices. For example, when each of the types of wireless connections are classic Bluetooth connections, the accessory may align the time slots for each classic Bluetooth connection. The time slot boundary of the aligned time slots may be the time for the accessory to simultaneously receive content from each of the host devices. In some examples, where a first type of wireless connection is a classic Bluetooth connection and a second type of wireless connection is a BLE connection, the accessory may align the time slot of the classic Bluetooth connection to the anchor point of the BLE connection event or broadcast BLE connection event. In particular, the accessory determines a first and a second start time for transmission or receipt of content over the first and second wireless communication interface (e.g., depending on the type of the wireless connections), respectively, compares a difference between the first start time and the second start time to a threshold value and adjusts, based on the difference being greater than the threshold value, the first start time, the second start time, or both start times such that the difference between the first start time and the second start time is below the threshold value.

In some examples, each of the types of wireless connections may be a classic Bluetooth connection. In such an example, determining the time for the accessory to simultaneously receive content from each of the two or more host devices may include aligning a time slot boundary for each of the wireless connections. The accessory may apply clock dragging to align the time slot boundary for each of the wireless connections.

In another example, a first determined wireless connection may be a classic Bluetooth connection and a second determined wireless connection may be a Bluetooth low energy connection. In such an example, determining the time for the accessory to simultaneously receive content from each of the two or more host devices may include aligning a time slot boundary of the first determined wireless connection and a connection event anchor point of the second wireless connection.

In one example, each of the types of wireless connections may be a Bluetooth low energy connection. In such an example, determining the time for the accessory to simultaneously receive content from each of the two or more host devices may include aligning a connection event anchor point for each of the wireless connection

In block 1030, the accessory may output the content received from each of the two or more host devices simultaneously.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

### Additional Examples

In the following section, examples are provided.

Example 1: A method, comprising: establishing a first wireless communication interface with a first host device, the first wireless communication interface configured to receive a first content from the first host device or to transmit the first content to the first host device; establishing a second wireless communication interface with a second host device, the second wireless communication interface configured to receive a second content from a second host device or to transmit the second content to the second host device; determining: a first start time for transmission or receipt of the first content over the first wireless communication interface; and a second start time for transmission or receipt of the second content over the second wireless communication interface; comparing a difference between the first start time and the second start time to a threshold value; and adjusting, based on the difference being greater than the threshold value, the first start time, the second start time, or both start times such that the difference between the first start time and the second start time is below the threshold value.

Example 2: The method of example 1, wherein the adjusting comprises applying clock dragging, wherein clock dragging comprises changing the length of a connection time slot.

Example 3: The method of example 1 or 2, wherein the adjusting comprises changing a connection event anchor point, wherein the connection event anchor point comprises a time when a device begins data packet traffic.

Example 4: The method of any one of the previous examples, further comprising transmitting or receiving both first and second content.

Example 5: The method of any one of examples 1-3, further comprising, based on the first content (680a) requiring less time than the second content (680b) to transmit or receive, transmitting or receiving only the first content (680a).

Example 6: The method of example 5, further comprising, based on the second content (680b) not being transmitted or received over a predetermined period of time, transmitting or receiving only the second content (680b).

Example 7: The method of any one of the previous examples, wherein the first and second host devices are unicast devices.

Example 8: The method of any one of examples 1-3, further comprising, based on the first start time not being adjusted and the second start time being adjusted, transmitting or receiving only the first content (680a).

Example 9: The method of example 8, further comprising, based on the second content (680b) not being transmitted or received over a predetermined period of time, transmitting or receiving only the second content (680b).

Example 10: The method of example 8, further comprising: determining a connection event (580a) comprising a time wherein first content and second content may be transmitted or received; based on the second content (680b) not being transmitted or received during a connection event, assigning a credit to the second wireless communication interface (142, 242); and based on the number of credits exceeding a threshold number of credits, transmitting or receiving only the second content (680b).

Example 11: The method of any one of examples 8-10, wherein the first host device is a broadcast device and the second host device is a unicast device.

Example 12: The method of any one of the previous examples, wherein the first wireless communications interface comprises a first frequency band and the second wireless communications interface comprises a second frequency band, the first frequency band being different than the second frequency band.

Example 13: The method of any one of the previous examples, further comprising identifying a type of a wireless connection between the first and/or the second wireless communications interface and their respective host devices, wherein the first and/or the second start time is determined based on the identified type of the wireless connection.

Example 14: The method of any one of the previous examples, wherein the wireless communications interfaces are associated with a type, the type including a classic Bluetooth connection, a Bluetooth low energy connection, or a Bluetooth low energy broadcast connection.

Example 15: The method of any one of the previous examples, wherein the first wireless communication interface belongs to an accessory and the second wireless communication interface belongs to the same accessory.

Example 16: An electronic accessory, comprising: two or more wireless communication interfaces configured to receive content from one or more host devices; a memory; one or more processors, the one or more processors configured to execute the method of any one of examples 1-15 using the two or more wireless communication interfaces.

Example 17: A non-transitory computer readable memory storing instructions, which when executed by one or more processors cause the processors to execute any one of the methods of examples 1-15 using two or more wireless communication interfaces.

Example 18: An accessory, comprising: two or more wireless communications interfaces, including a first interface adapted to receive first content from a first host device and a second interface adapted to receive second content from a second host device; a memory; and one or more processors in communication with the memory and the two or more wireless communications interfaces, the one or more processors configured to: identify a type of wireless connection between each of the two or more wireless communications interfaces and their respective host devices; determine, based on the types of wireless connections, a time for the accessory to simultaneously receive content from each of the first and second host devices or transmit content to each of the first and second host devices; and output the content received from each of the first and second host devices simultaneously.

Example 19: The accessory of example 18, wherein the type of wireless connections include a classic Bluetooth connection, a Bluetooth low energy connection, or a Bluetooth low energy broadcast connection.

Example 20: The accessory of example 19, wherein: each of the types of wireless connections is a classic Bluetooth connection, and when determining the time for the accessory to simultaneously receive content from each of the first and second host devices the one or more processors are further configured to align a time slot boundary for each of the wireless connections.

Example 21: The accessory of example 20, wherein the one or more processors are configured to apply clock dragging to align the time slot boundary for each of the wireless connections.

Example 22: The accessory of example 19, wherein: a first determined wireless connection is a classic Bluetooth connection and a second determined wireless connection is a Bluetooth low energy connection, and when determining the time for the accessory to simultaneously receive content from each of the first and second host devices the one or more processors are further configured to align a time slot boundary of the first determined wireless connection and a connection event anchor point of the second wireless connection.

Example 23: The accessory of example 19, wherein: each of the types of wireless connections is a Bluetooth low energy connection, and when determining the time for the accessory to simultaneously receive content from each of the first and second host devices the one or more processors are further configured to align a connection event anchor point for each of the wireless connection.

Example 24: The accessory of example 18, further comprising an antenna in communication with each of the two or more wireless communications interfaces and configured to receive the content from each of the first and second host devices.

Example 25: The accessory of example 18, wherein each of the two or more wireless communications interfaces is a Bluetooth radio.

Example 26: A method, comprising: identifying, by one or more processors in communication with two or more wireless communications interfaces, a type of wireless connection between each of the two or more wireless communications interfaces and their respective host devices, wherein the two or more wireless communications interfaces includes a first interface adapted to receive first content from a first host device and a second interface adapted to receive second content from a second host device; determining, by the one or more processors based on the types of wireless connections, a time for the accessory to simultaneously receive content from each of the first and second host devices or transmit content to each of the first and second host devices; and outputting the content received from each of the first and second host devices simultaneously.

Example 27: The method of example 26, wherein the type of wireless connections include a classic Bluetooth connection, a Bluetooth low energy connection, or a Bluetooth low energy broadcast connection.

Example 28: The method of example 27, wherein: each of the types of wireless connections is a classic Bluetooth connection, and when determining the time for the accessory to simultaneously receive content from each of the first and second host devices the method further includes aligning, by the one or more processors, a time slot boundary for each of the wireless connections.

Example 29: The method of example 28, wherein the one or more processors are configured to apply clock dragging to align the time slot boundary for each of the wireless connections.

Example 30: The method of example 27, wherein: a first determined wireless connection is a classic Bluetooth connection and a second determined wireless connection is a Bluetooth low energy connection, and when determining the time for the accessory to simultaneously receive content from each of the first and second host devices the method further includes aligning, by the one or more processors, a time slot boundary of the first determined wireless connection and a connection event anchor point of the second wireless connection.

Example 31: The method of example 27, wherein: each of the types of wireless connections is a Bluetooth low energy connection, and when determining the time for the accessory to simultaneously receive content from each of the first and second host devices the method further includes aligning, by the one or more processors, a connection event anchor point for each of the wireless connection.

Example 32: The method of example 26, further comprising an antenna in communication with each of the two or more wireless communications interfaces and configured to receive the content from each of the first and second host devices.

Example 33: The method of example 26, wherein each of the two or more wireless communications interfaces is a Bluetooth radio.

Example 34: A non-transitory computer-readable medium storing instructions, which when executed by one or more processors, cause the one or more processors to: identify a type of wireless connection between each of two or more wireless communications interfaces and their respective host devices, wherein the two or more wireless communications interfaces includes a first interface adapted to receive first content from a first host device and a second interface adapted to receive second content from a second host device; determine, based on the types of wireless connections, a time for the accessory to simultaneously receive content from each of the first and second host devices or transmit content to each of the first and second host devices; and output the content received from each of the first and second host devices simultaneously.

Example 35: The non-transitory computer-readable medium of example 34, wherein the type of wireless connections include a classic Bluetooth connection, a Bluetooth low energy connection, or a Bluetooth low energy broadcast connection.

Example 36: The non-transitory computer-readable medium of example 35, wherein: each of the types of wireless connections is a classic Bluetooth connection, and when determining the time for the accessory to simultaneously receive content from each of the first and second host devices the one or more processors are further configured to align a time slot boundary for each of the wireless connections.

Example 37: The non-transitory computer-readable medium of example 36, wherein the one or more processors are configured to apply clock dragging to align the time slot boundary for each of the wireless connections.

### Conclusion

Although implementations of devices, methods, and systems directed to multiple audio stream handling with a multi-radio Bluetooth system have been described in language specific to features and/or methods, it is to be understood that the subject of the appended claims is not necessarily limited to the specific features or methods described. Rather, the specific features and methods are disclosed as example implementations of devices, methods, and systems directed to multiple audio stream handling with a multi-radio Bluetooth system.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

1. A method, comprising:
establishing a first wireless communication interface with a first host device, the first wireless communication interface configured to receive a first content from the first host device or to transmit the first content to the first host device;
establishing a second wireless communication interface with a second host device, the second wireless communication interface configured to receive a second content from a second host device or to transmit the second content to the second host device;
determining:
a first start time for transmission or receipt of the first content over the first wireless communication interface; and
a second start time for transmission or receipt of the second content over the second wireless communication interface;
comparing a difference between the first start time and the second start time to a threshold value; and
adjusting, based on the difference being greater than the threshold value, the first start time, the second start time, or both start times such that the difference between the first start time and the second start time is below the threshold value.

2. The method of claim 1, wherein the adjusting comprises applying clock dragging that changes a length of a connection time slot.

3. The method of claim 1, wherein the adjusting comprises changing a connection event anchor point, the connection event anchor point comprising a time when a device begins data packet traffic.

4. The method of claim 1, further comprising transmitting or receiving both first and second content.

5. The method of claim 1, further comprising, based on the first content requiring less time than the second content to transmit or receive, transmitting or receiving only the first content.

6. The method of claim 5, further comprising, based on the second content not being transmitted or received over a predetermined period of time, transmitting or receiving only the second content.

7. The method of claim 1, wherein the first and second host devices are unicast devices.

8. The method of claim 1, further comprising, based on the first start time not being adjusted and the second start time being adjusted, transmitting or receiving only the first content.

9. The method of claim 8, further comprising, based on the second content not being transmitted or received over a predetermined period of time, transmitting or receiving only the second content.

10. The method of claim 8, further comprising:
determining a connection event comprising a time wherein the first content and the second content may be transmitted or received;
based on the second content not being transmitted or received during a connection event, assigning a credit to the second wireless communication interface; and
based on the number of credits exceeding a threshold number of credits, transmitting or receiving only the second content.

11. The method of claim 8, wherein the first host device is a broadcast device and the second host device is a unicast device.

12. The method of claim 1, wherein the first wireless communications interface comprises a first frequency band and the second wireless communications interface comprises a second frequency band, the first frequency band being different than the second frequency band.

13. The method of claim 1, further comprising identifying a type of a wireless connection between the first and/or the second wireless communications interface and their respective host devices, wherein the first and/or the second start time is determined based on the identified type of the wireless connection.

14. The method of claim 1, wherein the wireless communications interfaces are associated with a type, the type including a classic Bluetooth connection, a Bluetooth low energy connection, or a Bluetooth low energy broadcast connection.

15. The method of claim 1, wherein the first wireless communication interface belongs to an accessory and the second wireless communication interface belongs to the same accessory.

16. An electronic accessory, comprising:
two or more wireless communication interfaces configured to receive or transmit content from one or more host devices;
a memory;
one or more processors, the one or more processors configured to:
determine:
a first start time for transmission or receipt, over a first wireless communication interface of the two or more wireless communication interfaces, of a first content to or from a first host device; and
a second start time for transmission or receipt, over a second wireless communication interface of the two or more wireless communication interfaces, of a second content to or from a second host device;
compare a difference between the first start time and the second start time to a threshold value; and
adjust, based on the difference being greater than the threshold value, the first start time, the second start time, or both start times such that the difference between the first start time and the second start time is below the threshold value.

17. A non-transitory computer readable memory storing instructions, which when executed by one or more processors cause the processors to:
determine:
a first start time for transmission or receipt, over a first wireless communication interface of two or more wireless communication interfaces configured to receive or transmit content from one or more host devices, of a first content to or from a first host device; and
a second start time for transmission or receipt, over a second wireless communication interface of the two or more wireless communication interfaces, of a second content to or from a second host device;
compare a difference between the first start time and the second start time to a threshold value; and
adjust, based on the difference being greater than the threshold value, the first start time, the second start time, or both start times such that the difference between the first start time and the second start time is below the threshold value.

18. The electronic accessory of claim 16, wherein the adjusting comprises applying clock dragging that changes a length of a connection time slot.

19. The electronic accessory of claim 16, wherein the adjusting comprises changing a connection event anchor point, the connection event anchor point comprising a time when a device begins data packet traffic

20. The non-transitory computer readable memory of claim 17, wherein the adjusting comprises applying clock dragging that changes a length of a connection time slot.
